(19) United States
(12) Patent Application Publication
(10) Pub. No.: US 2006/0287147 A1
(43) Pub. Date: Dec. 21, 2006

(54) Shock absorbing endless belt for a treadmill

(76) Inventor: Matthew Kriesel, Melrose, WI (US)

Correspondence Address: Steven L. Schmid, 44 Coral Street, Atlantic Beach, FL, 32233, US

(21) Appl. No.: 11/326,594

(22) Filed: Jan. 3, 2006

Related U.S. Application Data
(60) Provisional application No. 60/641,654, filed on Jan. 4, 2005.

(51) Int. Cl. F16G 1/00; F16G 9/00; B29D 17/00

(52) U.S. Cl. 474/237; 156/137; 474/264

(57) ABSTRACT

Disclosed is an energy absorbing endless belt comprises a polymeric gel and a substrate enveloped by a top and bottom layer. The top layer may serve as the running surface for the treadmill and may be made of a different material than the bottom layer. The substrate has a density less than that of the polymeric gel. The substrate may be formed from a foamed plastic and may be a continuous sheet or have perforations placed throughout. The energy absorbing endless belt can be formed from an epoxidized vegetable oil, a thermoplastic polymer and a prepolymer.

### RELATED APPLICATION

This application relies upon U.S. Provisional Patent Application Ser. No. 60/641654 filed Jan. 4, 2005.

### FIELD OF THE INVENTION

The present invention relates to treadmills more specifically the present invention relates to treadmills with a shock absorbing endless belt.

### BACKGROUND

Exercise treadmills are widely used for various purposes. Exercise treadmills are, for example, used for performing walking or running aerobic-type exercise while the user remains in a relatively stationary position, further, exercise treadmills are used for diagnostic and therapeutic purposes. For all of these purposes, the person on the exercise treadmill normally performs an exercise routine at a relatively steady and continuous level of physical activity. Examples of such treadmills are illustrated in U.S. Pat. Nos. 4,635,928, 4,659,074, 4,664,371, 4,334,676, 4,635,927, 4,643,418, 4,749,181, 4,614,337 and 3,711,812, the contents of each are hereby incorporated in their entirety.

Exercise treadmills typically have an endless running surface which is extended between and movable around two substantially parallel pulleys at each end of the treadmill. The running surface may be comprised of a belt of a rubber-like material, or alternatively, the running surface may be comprised of a number of slats positioned substantially parallel to one another attached to one or more bands which are extended around the pulleys. In either case, the belt or band is relatively thin. The belt is normally driven by a motor rotating the front pulley. The speed of the motor is adjustable by the user so that the level of exercise can be adjusted to simulate running or walking as desired.

The belt is typically supported along at least its upper length between the pulleys by one of several well-known designs in order to support the weight of the user. For example, rollers may be positioned directly below the belt to support the weight of the user. Another approach is to provide a deck or support surface beneath the belt, such as a wood panel, in order to provide the required support. Here a low-friction sheet or laminate is usually provided on the deck surface to reduce the friction between the deck surface and the belt Because the belt engages the deck surface, friction between the belt and the deck arises and the belt is therefore subject to wear. Further, most of the decks are rigid resulting in high impact loads as the user's feet contact the belt and the deck. This is often perceived by users as being uncomfortable and further can result in unnecessary damage to joints as compared to running on a softer surface.

Because the typical treadmill has a very stiff, hard running surface and can become uncomfortable for extended periods or running, some manufacturers have applied a resilient coating to the running surface, such as rubber or carpeting, to reduce foot impact. Unfortunately, these surfaces for the most part have not provided the desired level of comfort because the running surface tends to retain its inherent stiffness. Attempts to solve this problem by using a thicker belt to provide a more shock absorbent running surface have not been successful for the reasons given in U.S. Pat. No. 4,614,337. Specifically, the thickness of the belt has to be limited in order to limit the belt drive power to reasonable levels. In other words, the thicker the belt, the more power that is required to drive the pulley. To keep motor size cost effective, it has been necessary to keep the belt relatively thin. As discussed below, the power of the motor required to drive a pulley is also related to the size of the pulleys.

Pulleys used in current exercise treadmills typically are made of steel or aluminum and as such are relatively expensive to make and are relatively heavy. Therefore, because of tooling, manufacturing and material costs, the diameter of the pulleys are normally no larger than three to four inches.

Additionally, the diameter of the pulley directly affects the power required to rotate the pulley as does the thickness of the belt. If the diameter of the pulleys is relatively small, the thickness of the belt must be kept relatively thin. As the diameter of the pulley is increased, the belt may be made thicker for the same amount of power available to drive the pulleys. As discussed above, the thicker the belt, the more shock the belt will absorb.

Thus, what is needed is a cushioned endless belt whose thickness does not require the increase in the diameter of the pulleys while providing the needed shock absorbing characteristics to prevent injury to the runner.

### SUMMARY

The present invention generally relates to a reinforced polymeric belt for absorbing energy on a treadmill as an endless belt of the treadmill. The endless belt exhibits low rebound velocity and high hysteresis, among other desirable characteristics that are conducive to the function of a good energy attenuating material. Furthermore, the endless belt is at such a width as to not require that the diameter of a treadmill pulley to be increased. needs to be increased due to the increased.

Generally the energy absorbing endless belt comprises a polymeric gel and a substrate enveloped by a top and bottom layer. The top layer may serve as the running surface for the treadmill and may be made of a different material than the bottom layer. The substrate has a density less than that of the polymeric gel. The substrate may be formed from a foamed plastic and may be a continuous sheet or have perforations placed throughout. The energy absorbing endless belt can be formed from an epoxidized vegetable oil, a thermoplastic polymer and a prepolymer. The epoxidized vegetable oil generally encompasses either an epoxidized soybean or linseed oil, or combinations of the two. The top and bottom layer can be formed from a non-woven resilient material or from a woven material. Furthermore, a third layer may be added to top layer for added support and durability.

In an additional embodiment, the energy absorbing endless belt comprises a gel formed from an epoxidized vegetable oil and a thermoplastic polymer which is substantially free of a polyurethane, and a substrate formed from a foamed plastic. The foamed plastic has a density less than that of the polymeric gel. The energy absorbing endless belt comprises an envelope formed from two opposed layers joined at the periphery. The gel and substrate are contained within the envelope, and in one embodiment, the gel surrounds the substrate.

A further embodiment includes a method of forming a energy absorbing endless belt by joining two opposed layers to form an envelope containing within a polymeric gel and a substrate. The opposed layers may be fused together at the periphery using heat or may be mechanically joined. The layers can be formed from a resilient non-woven material and have a third layer formed from most any material commonly used to form endless belts in treadmills.

### DRAWINGS

In the Drawings:

FIG. 1 depicts a cross sectional view of the energy absorbing endless belt; and

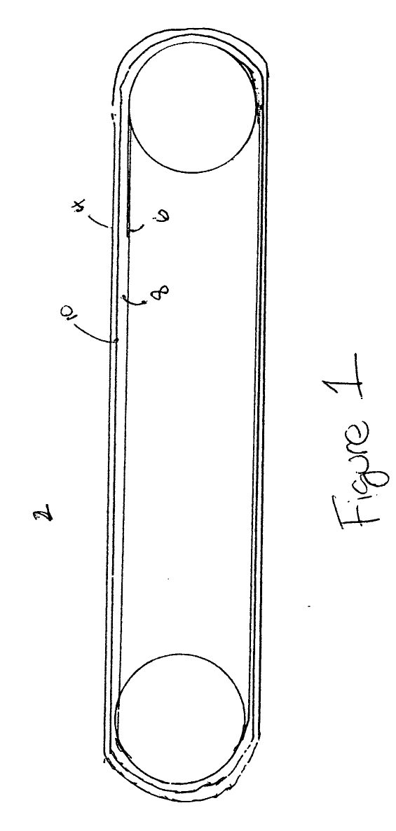

FIG. 2 illustrates a treadmill and endless belt configuration.

### DETAILED DESCRIPTION

In greater detail, the present invention comprising a reinforced polymeric belt including a shock absorbing envelope comprising a polymer gel and a substrate. The shock absorbing envelope is formed by the joining of two opposed layers 4, 6 joined at the periphery to comprise a compartment formed between the two layers 4, 6 wherein a substrate and polymeric gel are contained.

The layers 4, 6 defining the envelope are typically formed from a non-woven material such as a resilient polymeric polymer sheet and are capable of withstanding repeated impact. The two opposed layers 4, 6 defining the envelope in which the polymeric material and substrate 10 are contained, may be formed of most any material capable of providing impact resistance.

The substrate 10 typically has a density less than that of the polymeric gel 8 and decreases the overall weight of the belt 2 while adding some rigidity to the belt. The substrate 10 may be formed of most any material so long as it does not impede the impact resistance of the reinforced belt 2. For example, the substrate 10 may be formed from a foamed plastic such as a polyvinyl chloride, or the substrate 10 may be formed from a felt material.

The polymeric gel 8 component of the reinforced belt 2 may be comprised of most any elastomeric material. While the gel 8 component is described as a polymeric gel 8, the term “gel” is not meant to be restrictive and is only used to describe the component as having gel-like qualities. The use of the term “gel” is not intended to be restrictive as to describing only a colloidal system, but is used to describe any semi-solid substance that is both resilient and elastic. Typically, the polymeric gel 8 is formed an epoxidized vegetable oil combined with a prepolymer and a thermoplastic polymer. The gel 8 compound is capable of absorbing impact and energy and has a density greater than that of the substrate 10.

Opposed Layers

The opposed layers 4, 6 defining an envelope therebetween, can be fused together using heat if the layers 4, 6 are formed from a material conducive to such fusing. An example of a fusible material would be a vinyl sheet or other polymeric material that melts and fuses upon solidification Additionally the layers 4, 6 may be joined using mechanical means such as stitching, stapling or other fasteners. Adhesives may also be used to join the layers 4, 6 together, or a combination of any of the methods mentioned above or those known in the art may be used for joining the layers 4, 6.

The reinforced polymeric shock absorbing belt 2 may be comprised of one or 15 more envelopes residing in a single belt 2 The two opposed layers 4, 6 may be joined at multiple points creating a plurality of envelopes encompassing the substrate 10 and gel compound.

The opposed layers 4, 6 may be formed from a sheet of a resilient polymeric matenal Additionally, the opposed layers 4, 6 may be formed from a woven or a non-woven matenal capable of containing the gel 8 and substrate 10 and able to withstand ruptuttng upon impact Furthermore, it is contemplated that the envelope may be comprised of more that two layers 4, 6 and that the envelope may be encased in a further envelope to add protection and durability to the belt 2.

Substrate

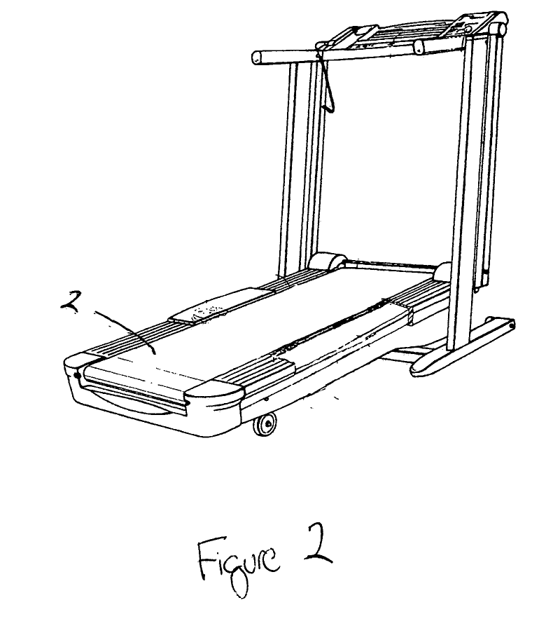

The substrate 10 functions essentially as a filler for providing both weight reduction in the belt 2 and rigidity. The substrate 10 may be formed from a foam polymer such as a PVC, or a nonwoven material such as a felt belt. Additionally, other materials are also known in the art, which have a density less than the gel 8 and can provide the same functions. The substrate 10 may formed from a continuous sheet of material or may have perforations as illustrated in FIG. 2 Additionally, the substrate 10 may substantially span the entire envelope or Just reside in a portion of the envelope. In one embodiment it is contemplated that the substrate 10 spans at least 50% or more of the area of the belt 2 In a further embodiment, the substrate 10 spans at least 75% of the belt 2. The thickness of the substrate 10 is limited only be the desired ultimate thickness of the belt 2 and the desired overall weight in the belt 2 Furthermore, the 15 substrate 10 may be a continuous sheet or be comprised of multiple sheets within the belt 2. It is further contemplated that the substrate 10 may be comprised of particles such as foamed beads of PVC, which are less dense that the polymeric gel 8.

Polymenc Gel

The energy absorbing polymeric compound may be comprised of most any polymeric gel Typically, and in an embodiment, the gel 8 has a density greater than the substrate 10. The gel 8 incorporated into the envelope is both viscoelastic and shock-attenuating.

An example gel 8 compound is one that comprises an epoxidized vegetable oil combined with a prepolymer and a thermoplastic polymer Additionally, a catalyst or an accelerant may be added to the energy absorbing compound to aid in the formation of the compound. Typically the activator or accelerant is a metal activator such as an alkyl tin compound.

The elastomeric compound includes an epoxidized vegetable oil which can function as a plasticizer. By way of example, the epoxidized vegetable oils can include epoxidized soybean oil, epoxidized linseed oil and epoxidized tall oil. Additional examples of epoxidized vegetable oils include epoxidized corn oil, epoxidized cottonseed oil, epoxidized perilla oil and epoxidized safflower oil. Epoxidized vegetable oils are typically obtained by the epoxidation of tnglycendes of unsaturated fatty acid and are made by epoxidizing the reactive olefin groups of the naturally occumng tnglycende oils Typically, the olefin groups are epoxidized using a peracid. One example of an acceptable epoxidized vegetable oil is an epoxidized soybean oil, Paraplex G-62, available from C P Hall Company of Chicago, Ill. Paraplex G-62 can function as both a plasticizer and a processing aid and is a high molecular weight epoxidized soybean oil having an auxiliary stabilizer for a vinyl group.

The elastomeric composition includes a prepolymer. Various prepolymers 20 may be utilized in the present composition so long as they do not substantially hinder the desired viscoelastic, shock-attenuating attributes of the elastomenc compound. Typically, the prepolymer is an isocyanate.

The thermoplastic components can include most any thermoplastic compound having elastomeric properties. In one embodiment of the gel 8, thermoplastic compounds comprising polyurethane are excluded. Acceptable thermoplastic component includes polydienes. An example polydiene mcludes polybutadiene. Typically, the activator or catalyst is an alkyl tin compound is also added to the gel 8 compound. A specific example of an alkyl tin compound is a dioctyltin carboxylate.

It is within the scope of the present invention to incorporate other additives such as fillers, pigments, surfactants, plasticizers, organic blowing agents, as stabilizers, and the like, in the manufacture of the reinforced polymericc shock absorbing belt 2.

While Applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

1. A reinforced polymeric endless belt comprising:
a shock absorbing envelope comprising a polymer gel substantially surrounding a substrate.

2. The reinforced polymeric belt of claim 1, wherein the belt comprises a top layer and a bottom layer.

3. The reinforced polymeric belt of claim 2, wherein the layers are formed from a resilient polymeric material.

4 The reinforced polymeric belt of claim 2, wherein the layers are formed from a woven material.

5. The reinforced polymeric belt of claim 1, wherein the substrate has a density less than the polymeric gel.

6. The reinforced polymeric belt of claim 1, wherein the substrate is formed from a foamed polymeric material.

7. The reinforced polymeric belt of claim 6, wherein the substrate is formed from a foamed PVC.

8. The reinforced polymeric paid of claim 1, wherein the polymeric material comprises at least greater than 50% by weight of an epoxidized vegetable oil, a thermoplastic polymer, and a prepolymer.

9. The reinforced polymeric belt of claim 8, further including an activator.

10. The reinforced polymeric belt of claim 9, wherein the activator is an alkyl tin compound.

11. The reinforced polymeric belt of claim 8, wherein the epoxidized vegetable oil is selected from the group consisting of soybean oil, linseed oil, and combinations thereof.

12. The reinforced polymeric belt of claim 8, wherein the prepolymer comprises an isocyanate selected from the group of aliphatic, cycloaliphatic, araliphatic, aromatic, heterocychc polyisocyamates and combinations thereof.

13. The reinforced polymeric belt of claim 8, wherein in the thermoplastic polymer is substantially free of a polyurethane.

14. The reinforced polymeric belt of claim 8, wherein the thermoplastic polymer comprises a polydiene.

15. The reinforced polymeric belt of claim 8, wherein the thermoplastic polymer is a polybutadiene.

16. A reinforced polymeric endless belt comprising:
a shock absorbing envelope comprising a top and bottom layer forming the envelope containing a polymeric gel and a substrate having a density less than the density of the polymeric gel

17. The reinforced polymeric belt of claim 16, wherein the substrate is formed from a foamed polymeric material.

18 The reinforced polymeric belt of claim 16, wherein the top and bottom layers are formed from a resilient non-woven material.

19. The reinforced polymeric belt of claim 16, comprising an epoxidized vegetable oil, a thermoplastic polymer substantially free of a polyurethane and a prepolymer

20. The reinforced polymeric belt of claim 16, further including an activator.

21 The reinforced polymeric belt of claim 20, wherein the activator is an alkyl tin compound.

22. The reinforced polymeric belt of claim 16, wherein the prepolymer comprises an isocyanate selected from the group of aliphatic, cycloaliphatic, araliphatic, aromatic, heterocyclic polyisocyaniates and combinations thereof.

23. The reinforced polymeric belt of claim 16, wherein the polymeric gel comprises on a percent weight basis of the gel at least greater than about 50% of a vegetable based plasticizer, between about 20% and about 40% of a thermoplastic polymer, and between about 5% and about 20% of a prepolymer.

24. A method of forming a reinforced polymeric belt comprising:
forming a shock absorbing envelope by sealing within a top and bottom layer a polymeric gel and a substrate having a density less than the density of the polymeric gel.

25. The method of forming a reinforced polymeric of claim 24 wherein the polymeric gel if formed by combining an epoxidized vegetable oil, a polydiene and a cyano group

26. The method of forming a reinforced polymeric belt of claim 24, wherein the polydiene is selected from polybutadiene, polyisoprene, polychioroprene, polynobornene, copolymers, terpolymers and combinations thereof.

27. The method of forming a reinforced polymeric of claim 24, wherein the top and bottom layer are sealed by fusing the two layers along the periphery of the belt.

28. The reinforced polymeric belt of claim 24, wherein the gel comprises about 20% to about 40% of the polydiene.

29. The reinforced polymeric belt of claim 24, wherein the cyano group is an isocyanate group.

30. The reinforced polymeric belt of claim 24, further comprising an alkyl tin compound.

31. The reinforced polymeric belt of claim 30, wherein the gel comprises up to about 5% by weight of the alkyl tin compound.
